(19) United States
(12) Patent Application Publication
(10) Pub. No.: US 2014/0240858 A1
(43) Pub. Date: Aug. 28, 2014

(54) MIRROR

(71) Applicant: AGC GLASS EUROPE, Louvain-La-Neuve (BE)

(72) Inventors: Nicolas Boucher, Gosselies (BE); Nicolas Clement, Gosselies (BE); Bruno Cosijns, Gosselies (BE); Thomas Lambricht, Gosselies (BE); Barbara De Maeyer, Lillois-Witterzee (BE); Joris Proost, Kessel-lo (BE)

(73) Assignee: AGC GLASS EUROPE, Louvain-La-Neuve (BE)

(21) Appl. No.: 14/353,208

(22) PCT Filed: Oct. 19, 2012
(86) PCT No.: PCT/EP12/70766

§ 371 Date: Apr. 21, 2014

(30) Foreign Application Priority Data
Oct. 21, 2011 (BE) BE 2011/0615

(51) Int. Cl. G02B 5/08

(52) U.S. Cl. CPC G02B 5/085; G02B 5/0875
USPC 359/838

(57) ABSTRACT

The invention relates to a mirror including a glass substrate covered with a silver layer, which is in turn covered with at least one paint layer, wherein the intensity ratio of the crystallographic orientations (111)/(200) within the silver layer is less than 5.0. Said mirror is characterized in that the silver layer has a correlation length (CLz) (111), as measured by X-ray diffraction using the Scherrer method (i.e., using the Scherrer equation) of greater than 27.0 nm.

This invention relates to mirrors and to methods for manufacturing such mirrors.

The mirrors according to this invention can have various applications, for example: domestic mirrors used, inter alia, in furniture, wardrobes or bathrooms; mirrors for make-up boxes or powder compacts; mirrors used in the automotive industry such as vehicle rear-view mirrors, for example. However, this invention can be particularly advantageous in the case of mirrors used as solar energy reflectors.

The mirrors according to the present invention can be used as reflectors in solar power plants. Such installations use solar energy to first produce heat, which can then be converted into electricity or used for the production of steam. Solar power plants in which mirrors according to the present invention can be used include, for example, parabolic trough power plants, dish-type power plants, tower power plants, Fresnel power plants and parabolic collector plants. Mirrors according to the present invention can be used as flat or curved reflectors.

Domestic mirrors and mirrors for solar applications are often produced using “wet chemistry” processes. Thus, in general, mirrors are produced using the following process: a sheet of flat glass (float, soda-lime glass) is firstly polished and rinsed, then sensitised using a solution of tin chloride; after rinsing, a layer of silver is deposited by reduction reaction of an ammoniacal silver nitrate solution. This silver layer is then covered with a protective layer of copper. After drying, one or more layers of leaded paint are applied to produce the finished mirror. The combination of the protective copper layer and the leaded paint was generally considered necessary to give the mirror acceptable ageing characteristics and adequate corrosion resistance.

More recently, mirrors have been developed that no longer required the traditional protective copper layer, which could use substantially lead-free paints and yet still exhibited acceptable or even improved ageing characteristics and corrosion resistance. For example, French patent FR 2719839 describes methods for producing mirrors with no copper layer comprising the following steps: treatment of the surface of the glass with tin chloride (sensitisation) and palladium chloride (activation); rinsing; formation of the silver layer; rinsing; treatment of the silvered surface with tin chloride (passivation); rinsing and drying; application of at least one paint layer. This new generation of mirrors marks a significant advance over traditional coppered mirrors.

A highly important property for a mirror for solar application is its ability to reflect the rays of the sun that is decisive for the output of the solar power plant in which it is installed. During operation, the rays of the sun pass through the glass substrate of the mirror a first time, are reflected on the silver layer, then pass through the glass substrate a second time. To increase the reflective properties of solar mirrors, it is known to use finer glass sheets as substrate for the mirrors or to use extra-clear glass, i.e. a glass with a total iron content, expressed as Fe₂O₃, of less than 0.02% by wt., thus reducing the absorbent effect of the glass with respect to solar radiation. It is also known to increase the quantity of silver present in the reflective silver layer: a quantity of silver in the vicinity of 1200-1500 mg/m² can prove to be a good compromise between favourable reflection values and an acceptable production cost. Mirrors, in which the substrate has an overlying layer on the silver layer side that is silver-enriched over a preferred thickness of between 130 and 700 nm, have also been proposed.

On the other hand, highly reflective mirrors are also produced by means of physical vapour deposition (PVD). They are distinguished from mirrors produced by the wet method by their crystallographic texture of the silver, in particular by the fact that the crystallographic orientation (111) within the silver layer is markedly dominant in relation to the orientation (200) resulting in an intensity ratio (111)/(200) higher than 10, generally higher than 20; whereas mirrors produced by the wet method have a (111)/(200) ratio lower than 5. However, mirrors produced by PVD have the disadvantage of a much more complex process and do not generally exhibit sufficient durability, particularly for solar applications. Nevertheless, the solar mirror industry is still seeking increased performances in terms of light and energy reflection, while still desiring mirrors with the longest possible service life.

According to one of its aspects, the present invention relates to a mirror according to claim 1 with dependent claims presenting preferred embodiments.

The invention relates to a mirror comprising a glass substrate covered with a silver layer that is itself covered with at least one paint layer, in which mirror the intensity ratio of the crystallographic orientations (111)/(200) within the silver layer is less than 5.0. It is characterised in that the silver layer has a correlation length (111) (CLz) measured by X-ray diffraction using the Scherrer method (i.e. using the Scherrer equation) greater than 27.0 nm.

Such mirrors produced by the wet method have the advantage of having a light reflection and/or energy reflection higher than that (those) of a mirror of identical production (inter alia, the same composition and thickness of the glass substrate, the same quantity of silver on the glass), but in which the silver layer has a crystallinity defined by a lower correlation length (111) (CLz). Moreover, this improvement in the reflective properties of the mirror is not achieved to the detriment of other important properties, e.g. the resistance to corrosion and/or ageing of the mirror.

We have thus discovered that higher reflection values are obtained when the correlation length of the silver crystallites (grains) of crystallographic orientation (111) increase, all other factors being equal.

According to preferred embodiments of the invention, the silver layer has a correlation length (111) (CLz) greater than 27.5, 28.0, 28.5, 29.0 or 29.5 nm, still more preferred greater than 30.0, 30.5 or 31.0 nm. The CLz can be less, for example, than 60.0, 50.0 or 45.0 nm. CLz values in these ranges allow increases in energy reflection of up to 2% compared to mirrors of the prior art that have lower CLz values.

The correlation length (111) (CLz) is calculated on the basis of the Bragg diffraction peaks obtained during an X-ray diffraction measurement performed in Bragg-Brentano configuration. The correlation length (CL) is in fact linked directly to the width of the peak at mid-height by the Scherrer equation:

CL=0.9λ/β cos θ

where β is the width at mid-height and λ is the wavelength.

The intensity ratio of crystallographic orientations (111)/(200) is calculated by dividing the maximum number of pulses/second of the peak corresponding to the orientation (111) in the X-ray diffraction spectrum by the maximum number of pulses/second corresponding to the orientation (200).

Advantageously, the silver layer is formed on a flat float, preferably extra-clear, glass i.e. a glass with a total iron content, expressed as Fe₂O₃, of less than 0.02% by wt. The extra-clear glass promotes favourable reflection values.

The quantity of silver deposited onto the glass is preferably higher than or equal to 800 mg/m², 1000 mg/m², 1200 mg/m² or 1400 mg/m²; it is preferably lower than 2000 mg/m², 1800 mg/m², 1600 mg/m² or 1500 mg/m². The thickness of the silver layer can be greater than or equal to 65 nm, 70 nm, 80 nm, 90 nm, 100 nm, 110 nm, 120 nm, 130 nm or 140 nm; it can be less than 200 nm, 180 nm, 160 nm or 150 nm. These values provide a good compromise between favourable reflection values and an acceptable production cost.

According to preferred embodiments of the invention, the silver layer has silver grains of an average size ranging between 10 nm and 200 nm, preferably between 20 nm and 120 nm. This average grain size can be determined by observations of the surface of the silver layer using SEM-FEG (scanning electron microscope with field emission guns).

The present invention can apply to mirrors with or without a protective copper layer between the silver layer and the paint layer or layers. Mirrors without a copper layer can be advantageous for the environment.

According to certain advantageous embodiments of the invention, one or more materials can be deposited during a step of activating the surface of the glass on which the silver layer must be deposited. This can contribute to the resistance to ageing and/or corrosion of the mirrors and/or their durability. This or these materials can be selected from the group of elements consisting of bismuth, chromium, gold, indium, nickel, palladium, platinum, rhodium, ruthenium, titanium, vanadium and zinc. Palladium is generally preferred.

Tin can be deposited during a step of sensitising the surface of the glass, on which the silver layer must be deposited. This can contribute to the good adhesion of the silver layer to the glass.

Advantageously, the mirror according to the invention contains tin and palladium present on the surface of the substrate on the silver layer side.

Preferably, one or more materials can be deposited during a step of passivating the surface of the silver layer, on which the paint must be deposited. This can contribute to the resistance to ageing and/or corrosion of the mirrors and/or their durability. This or these materials can be selected from the group of elements consisting of tin, palladium, vanadium, titanium, iron, indium, copper, aluminium, chromium, lanthanum, nickel, europium, zinc, platinum, ruthenium, rhodium, sodium, zirconium, yttrium and cerium. Tin or palladium is generally preferred.

The materials deposited on the surface of the glass during activation and/or sensitisation and/or deposited on the silver layer during passivation are preferably deposited as “islets”. This means that they do not form a distinct continuous layer, but are located discontinuously on the surface that they treat.

Advantageously, a treatment of the silver layer with a silane can be conducted before depositing the paint. The presence of traces of silane on the surface of the silver layer on the side with the paint layer or layers can contribute to the resistance of the mirror to mechanical stresses and/or corrosion.

The paint covering the silver layer is preferably lead-free or substantially lead-free. This can be beneficial to the environment. “Substantially lead-free” indicates that the proportion of lead in the paint is significantly less than the proportion of lead in the paints containing lead currently used in mirror production. The proportion of lead in a substantially lead-free paint as defined here is lower than 500 mg/m², preferably lower than 400 mg/m² or further preferred lower than 300 mg/m². The proportion of lead in a lead-free paint as defined here is lower than 100 mg/m², preferably lower than 80 mg/m² or further preferred lower than 60 mg/m². The paints used can be acrylic, epoxy, alkyd or polyurethane paints. They can be applied, for example, by roller or by curtain coating. The paint covering the silver layer can be deposited in a single step resulting in a single paint layer, or in several steps resulting in two or three paint layers. When several paint layers cover the silver, they can be identical in composition or different.

In accordance with ISO standard 9050:2003 (measured through the surface of the glass with an angle of incidence of 8° relative to the normal, with illuminant D65), the mirrors according to the present invention can have a light reflection higher than or equal to 85%, 90%, 91%, 92%, 93%, 94% or 95%. In accordance with ISO standard 9050:2003 (measured through the surface of the glass with an angle of incidence of 8° relative to the normal), the mirrors obtained by the present invention can have an energy reflection higher than or equal to 82%, 84%, 85% or 86% on clear glass or higher than or equal to 90%, 92% or 93% on extra-clear glass.

The mirrors according to the present invention can be so-called “thin” mirrors and be used, for example, for solar applications that require curved reflectors. For example, they have a thickness of more than 0.8 mm, 0.9 mm or 1.1 mm and/or less than 2 mm or 1.5 mm, e.g. a thickness of about 0.95 or 1.25 mm. They can also be thicker, e.g. for solar applications with flat reflectors, and have a thickness of more than 2 mm or 2.5 mm and/or less than 6 mm or 5 mm, for example.

Mirrors according to the invention are produced using wet chemistry processes. In practice, on a mirror production line, the glass sheets are generally transported along the production line by roller conveyors. They are firstly polished and rinsed before being sensitised, for example, by means of a tin chloride solution sprayed onto the glass. They are then rinsed again. An activation solution is then sprayed onto the glass sheets. This solution can be, for example, an aqueous acid solution of PdCl₂. The glass sheets then pass into a rinsing station where demineralised water is sprayed on, and then into the silvering station where a traditional silvering solution is sprayed on, this solution being the result of two separately sprayed solutions combining at the surface of the glass, one solution containing a silver salt and either a reducing agent or a base, the other containing either the reducing agent or the base absent from the solution containing the silver salt. The flow rate and concentration of the silvering solution sprayed onto the glass are controlled in order to form a silver layer of the desired thickness. The glass is then rinsed and directly thereafter an aqueous solution of SnCl₂, for example, is sprayed onto the glass sheets while they advance along the conveyor. After another rinse, the mirrors can be treated by spraying a solution containing a silane. After a last rinse, the silvered glass sheets enter a conventional drying station. The mirrors are then covered with one or more paint layers. Each paint layer is cured or dried before any further paint layer is applied, e.g. in a tunnel furnace. The paint is preferably applied to silvered substrates in the form of a continuous curtain of liquid paint dropping onto the glass sheets.

In another embodiment, after deposition of the silver layer the glass is rinsed and directly thereafter a copper salt and a silver reducing agent are sprayed on to form a copper layer on the surface of the glass. After another rinse, the silvered and coppered glass sheets enter a drying station and the process continues with the deposition of one or more paint layers.

In order to produce a silvered coated mirror having a CLz higher than 27.0 nm, several different adaptations can be applied to these general processes, either individually or in combination.

One of these consists of adapting the solutions sprayed on in the silvering step. Thus, we have found that we can obtain higher CLz values by selecting solutions from certain suppliers only.

Another consists of adjusting the system of spraying the silvering solutions (sprays), in particular the size of the drops and the orientation of the sprays.

A further adaptation consists of increasing the temperature in the step of drying the silver layer or extending this step.

Finally, another possibility is to produce the mirror on a glass covered with a layer that controls the growth of silver crystals, e.g. a thin crystallised dielectric layer of metal oxide or nitride of scarcely a few nm.

It is, of course, difficult to specify or be more precise about these tendencies here, since every mirror production line is different and has its special features. Nevertheless, by working on these few parameters that are well defined here, the person skilled in the art could obtain CLz values on his line by some trial and error testing without having to go to too much effort, since CLz measurements are easy to conduct and reasonably routine, and he could thus very easily determine the directions to follow to see his CLz values increase.

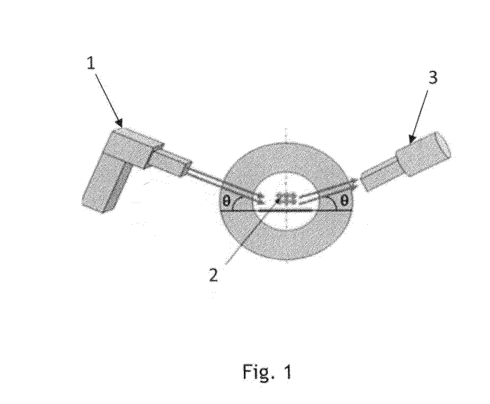

Some particular embodiments of the invention will now be described by way of examples in association with FIG. 1. This schematically shows a system of X-ray diffraction such as used to measure the correlation length (111) (CLz) and the ratio of intensity of crystallographic orientations (111)/(200). Comparative examples that do not form part of the invention are also presented. The data relating to these examples and comparative examples are shown in Table I.

### EXAMPLES 1-3 AND COMPARATIVE EXAMPLES 1-3

In all the following examples the XRD measurements were conducted by means of a D8-advance (Bruker) diffractometer used in Bragg-Brentano geometry (see FIG. 1). The range of angles measured extends from 5° to 70° in 0.009° steps in 2θ. The time interval is 0.2 s. A copper tube (1) (λKα₁=1.5415 Å) and a scintillation detector (3) are additionally used. The sample (2) is caused to rotate at 30 rpm to correctly measure the preferred orientations in relation to the vertical.

Examples 1 to 3 and comparative examples 1 to 3 relate to mirrors having a “float” glass substrate with a thickness of 4 mm of a clear glass composition (Example 1 and Comparative Example 1) or extra clear glass composition, i.e. with a total iron content, expressed as Fe₂O₃, of less than 0.02% by wt. (Examples 2 and 3 and Comparative Examples 2 and 3). All the examples have a quantity of silver of 1400 mg/m², and this is also the case in the comparative examples.

Examples 1 and Comparative Example 1 relate to mirrors with a copper layer, while Examples 2 and 3 and Comparative Examples 2 and 3 relate to mirrors without a copper layer.

The mirrors according to Examples 1a/2a, 1b/2b and 1c/2c underwent drying of the silver layer at temperatures of 250° C., 350° C. and 400° C. respectively for about 5-10 minutes. Comparative Examples 1/2 underwent drying at about 60° C. for one minute.

The mirrors according to Example 3 and Comparative Example 3 only differ with respect to the silvering solutions that come from two different suppliers.

The light reflection (LR) and energy reflection (ER) values of the mirrors are given in Table I. It can also be seen that the higher CLz values of the examples according to the invention allow higher LR and ER levels to be reached.

TABLE I

| | CLz [Å] | (111)/(200) | ER [%] | LR [%] |
|---|---|---|---|---|
| Example 1a | 274 | 2.00 | 84.15 | 92.15 |
| Example 1b | 316 | 2.10 | 84.23 | 92.25 |
| Example 1c | 301 | 2.00 | 84.15 | 92.14 |
| Comparative Example 1 | 198 | 1.90 | 83.55 | 91.45 |
| Example 2a | 326 | 2.55 | 92.32 | 93.91 |
| Example 2b | 342 | 2.51 | 92.96 | 94.93 |
| Example 2c | 373 | 2.44 | 92.54 | 94.27 |
| Comparative Example 2 | 218 | 2.83 | 91.32 | 92.73 |
| Example 3 | 294 | 3.02 | 94.06 | 95.88 |
| Comparative Example 3 | 254 | 3.17 | 92.83 | 94.28 |

1: A mirror, comprising:
a glass substrate covered with a silver layer that is covered with at least one paint layer,
wherein
an intensity ratio of crystallographic orientations (111)/(200) within the silver layer is less than 5.0, and
the silver layer has a correlation length (111) measured by X-ray diffraction using the Scherrer method greater than 27.0 nm.

2: The mirror according to claim 1, wherein the silver layer has a correlation length (111) greater than 28.0 nm.

3: The mirror according to claim 1, wherein the silver layer has a correlation length (111) greater than 30.0 nm.

4: The mirror according to claim 1, wherein the substrate is a glass with a total iron content, expressed as Fe₂O₃, of less than 0.02% by wt.

5: The mirror according to claim 1, wherein the silver layer has a thickness of from 70 to 150 nm.

6: The mirror according to claim 1, wherein the mirror comprises no copper layer.

7: The mirror according to claim 1, further comprising: tin present on a surface of the substrate on the silver layer side.

8: The mirror according to claim 1, further comprising: at least one element selected from the group consisting of bismuth, chromium, gold, indium, nickel, palladium, platinum, rhodium, ruthenium, titanium, vanadium and zinc present on a surface of the substrate on the silver layer side.

9: The mirror according to claim 1, further comprising: tin and palladium present on a surface of the substrate on the silver layer side.

10: The mirror according to claim 1, further comprising: at least one element selected from the group consisting of tin, palladium, vanadium, titanium, iron, indium, copper, aluminium, chromium, lanthanum, nickel, europium, zinc, platinum, ruthenium, rhodium, sodium, zirconium, yttrium and cerium present on a surface of the silver layer on the at least one paint layer side.

11: The mirror according to claim 1, further comprising: tin present on a surface of the silver layer on the at least one paint layer side.

12: The mirror according to claim 1, further comprising: traces of silane present on a surface of the silver layer on the at least one paint layer side.
